(19) United States
(12) Patent Application Publication
(10) Pub. No.: US 2017/0043495 A1
(43) Pub. Date: Feb. 16, 2017

(54) THREE DIMENSIONAL PART ROTARY DIE CUTTING MECHANISM AND METHOD OF OPERATING THE SAME

(71) Applicant: WESTROCK MWV, LLC, Richmond, VA (US)

(72) Inventors: Michael P. WADE, Chesterfield, VA (US); Barry G. CALVERT, Covington, VA (US)

(21) Appl. No.: 15/303,959

(22) PCT Filed: Dec. 19, 2014
(86) PCT No.: PCT/US2014/071413

§ 371 Date: Oct. 13, 2016

Related U.S. Application Data
(60) Provisional application No. 61/980,322, filed on Apr. 16, 2014.

(51) Int. Cl. B26F 1/38; B26D 7/01

(52) U.S. Cl. CPC B26F 1/384; B26D 7/018; B26F 2001/4481

(57) ABSTRACT

An apparatus and method for cutting three dimensional parts in a rotary die cutting mechanism (100) is provided including first and second drums (101 a,b) adjacent to each other to rotate about a respective axes, first and second recesses (106 a,b) formed on an outer surface of each of the drums in order to receive a three dimensional part, an anvil (103) protrudes outward from an edge of the first recess, and a cutting mechanism (104) protrudes outward from an edge of the second recess, the three dimensional part retained in a proper orientation to allow the three dimensional part to be cut by a first and a second capturing mechanism (105 a,b) disposed within the first and second recesses (106 a,b) respectively, configured to move in relation to the rotation of the drums (101 a,b).

### BACKGROUND OF THE INVENTION

Field of the Invention

The present invention relates generally to rotary die cutting apparatus and methods for operating the same. More specifically, the present invention relates to a blow molded packaging rotary die cutting mechanism.

State of the Art

Die cutting is the process of using a die to shear usually webs of a plethora of different types of materials, such as paper, rubber, fiber, foil, cloth, fiberboard, paperboard, plastics, pressure-sensitive adhesive tapes, foam, sheet metal, etc. Die cutting can be done on either flatbed or rotary presses. Flatbed die cutting is not as fast but the tools are cheaper and rotary cutting is much faster but is significantly more expensive. As such, flatbed presses often are used in smaller production runs where it is not as easy to absorb the added cost of a rotary die.

More specifically, rotary die cutting typically consists of a cylindrical die on a rotary press. A long sheet or web of material will be fed through the press into an area sometimes referred to in the industry as a “station,” which holds a rotary device that will cut out shapes on a board, make perforations or creases, or even cut the sheet or web into smaller portions. A series of gears are attached force the die to rotate at the same speed as the rest of the press, ensuring that any cuts the die makes line up with the appropriate cutting locations on the material. Rotary die cutting may be set up as individual or multiple stations that may make different cuts within the web. In each of these stations, however, lie one or more geared tools or drums that receive two dimensional webs for cutting.

Dies used in rotary die cutting are typically solid engraved dies, adjustable dies, or magnetic plate tooling. Engraved dies have a much higher tolerance and are machined out of a solid steel bar. Adjustable dies have removable blades that can be easily replaced with other blades, either due to wear or to cut a different material, while magnetic plate tooling has a cylinder that has magnets placed in it, and an engraved metal plate is attached or wrapped around the base cylinder holding onto it by the force of the magnets.

Regardless of the types of rotary dies that are employed, all of the current machines require the parts to be trimmed to be inserted in the form of web of material in order to maintain the trimmed parts in a perpendicular orientation to the cutting surface of the die. However, conventional rotatory die mechanisms do not have a tool for insuring the proper orientation of three dimensional parts and thus, it is required that the parts be fed into the rotary die in the form of a web. This restriction, however, slows down the cutting process making the rotary process much larger than is necessary or is not possible in some instances (i.e., when the part is three dimensional). Thus, it would be beneficial to be able to process the cutting of these three dimensional parts individually through a rotary die cutting mechanism.

### BRIEF SUMMARY OF THE INVENTION

According to certain embodiments of the invention, an apparatus for effectively and efficiently cutting three dimensional parts in a rotary die cutting mechanism is provided. In particular, first and second drums are installed adjacent to each other and rotate about a respective axes. Additionally, first and second recesses are formed on an outer surface of each of the drums in order to receive a three dimensional part. An anvil protrudes outward from the first recess, and a cutting mechanism protrudes outward from the second recess. In order to retain the three dimensional part in a proper orientation to allow the three dimensional part to be cut, a first and a second capturing mechanism is disposed within the first and second recesses respectively and are configured to move in relation to the rotation of the drums.

In another embodiment of the present invention, a method for effectively and efficiently trimming/cutting the three dimensional part is provided. In particular, the three dimensional part is fed into a rotary die mechanism which is continuously rotating. The three dimensional part is rotated toward a trimming position upon reaching the trimming position, the three dimensional part is retained in an in orientation that is perpendicular to a cutting surface on the rotary die cutting mechanism. The three dimensional part is then trimmed at the trimming position, and the trimmed three dimensional part is ejected from the rotary die cutting mechanism after the three dimensional part is rotated a distance from the trimming position.

Additionally, in some exemplary embodiments of the present invention, suction may be applied to the three dimensional part by at least one suction mechanism to further retain the three dimensional parts in the recess of the first drum.

Advantageously, the above mentioned capturing mechanisms utilized in combination with the rotary die cutting mechanism of the above illustrative embodiment, three dimensional parts may be trimmed effectively and efficiently because the capturing mechanisms maintain the three dimensional parts in the proper orientation in order to trim the part. Additionally, the number of three dimensional parts that can be trimmed per minute can be increased due to the degree of accuracy and efficiency of the described rotary die cutting mechanism and also due to the ability to abut two or more parts against each other and trim two or more parts at once.

### BRIEF DESCRIPTION OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1 illustrates an example perspective view of the overall configuration of the rotary die cutting mechanism;

FIG. 2 illustrates an example perspective view of the rotary die cutting mechanism assembly;

FIG. 3 illustrates an example perspective view of a first drum of the rotary die cutting mechanism;

FIG. 4 illustrates an example exploded view illustrating exemplary capturing mechanism for a rotary die cutting mechanism;

FIG. 5 illustrates an example exploded view illustrating exemplary suction mechanisms for the rotary die cutting mechanism;

FIG. 6 illustrates an example side view illustrating the trimming position at which an three dimensional part is cut; and

FIG. 7 illustrates an example illustrating a perspective view of the entire cutting process including the rotary die cutting mechanism of the illustrative embodiment of the present invention.

### DETAILED DESCRIPTION OF THE INVENTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

As stated above, regardless of the type of rotary die that is employed, all of the current machines require a web of material in order to maintain the trimmed parts in a perpendicular orientation in relation to the cutting surface of the die and thus are not practical for three dimensional parts. That is, conventional rotatory dies do not have a mechanism for insuring the proper orientation of three dimensional three dimensional parts and thus, it is required that the parts be fed into the rotary die in the form of a web. This restriction, slows down the cutting process or is not possible in some instances (i.e., when the part is three dimensional) and thus it would be beneficial to be able to process the cutting of these three dimensional parts individually through a rotary die cutting mechanism that is currently not available.

The techniques described herein are described as being utilized with packaging containers, however, the illustrative rotary die cutting apparatus is not limited to this use and may alternatively be used for cutting any three dimensional part. Advantageously, by utilizing capturing mechanisms which hold the die cutting surface of the three dimensional part perpendicular to a surface of an anvil and a cutting mechanism, the three dimensional parts may be trimmed effectively and efficiently because the capturing mechanisms maintain the three dimensional parts in the proper orientation for trimming of the part. Additionally, more than one three dimensional part may be trimmed by the same cut due to the recesses formed in surface of the drums of the rotary die cutting mechanism.

In one embodiment, an apparatus for effectively and efficiently cutting three dimensional parts in a rotary die cutting mechanism is provided. In particular, first and second drums are installed adjacent to each other and rotate about a respective axes. Additionally, first and second recesses are formed on an outer surface of each of the drums in order to receive a three dimensional part. An anvil protrudes outward from an edge of the first recess, and a cutting mechanism protrudes outward from an edge of the second recess. In order to retain the three dimensional part in a proper orientation to allow the three dimensional part to be cut, a first and a second capturing mechanism is disposed within the first and second recesses respectively and are configured to move in relation to the rotation of the drums.

Operationally, the three dimensional part is fed into a first capturing mechanism (i.e., of the pair of capturing mechanisms) attached to a first drum (i.e., of the pair of drums) within a first recess (i.e., of the pair of recesses) formed within a surface of the first drum. The first drum and a second drum are continuously rotated in opposing rotational directions. In doing so, the three dimensional parts are captured between the first capturing mechanism and a second capturing mechanism (i.e., of the pair of capturing mechanisms) disposed in a second recess of the second drum when the first drum and the second drum are rotated to a trimming position. Upon reaching the trimming position, the three dimensional part is trimmed via a cutting mechanism disposed on the first drum by coming into contact with the three dimensional part at the trimming position. Finally, once the three dimensional part is trimmed, the three dimensional part is ejected from the first capturing mechanism after the drums have rotated a distance (e.g., about 90 degrees) from the trimming position.

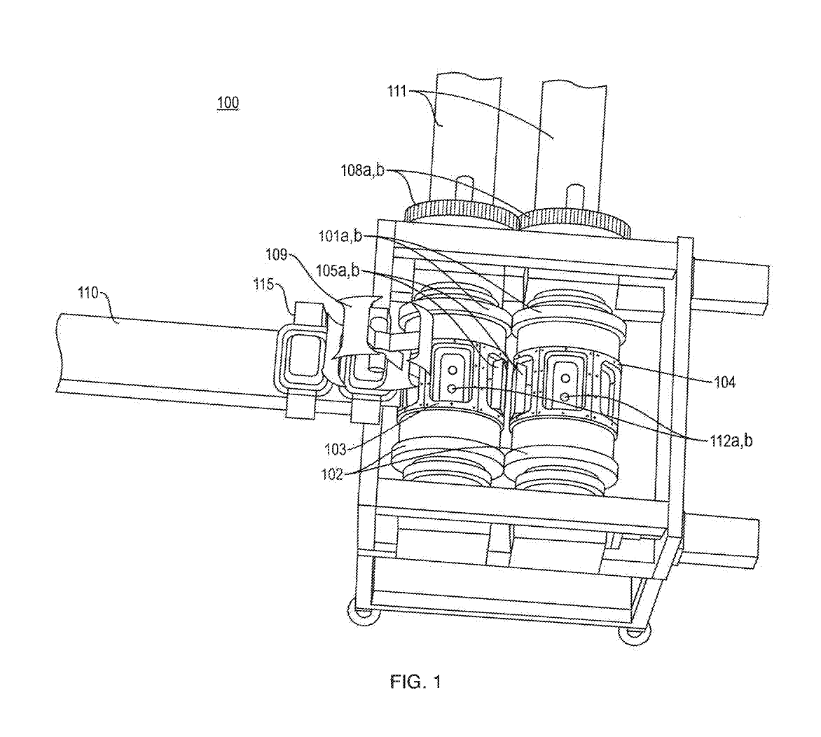

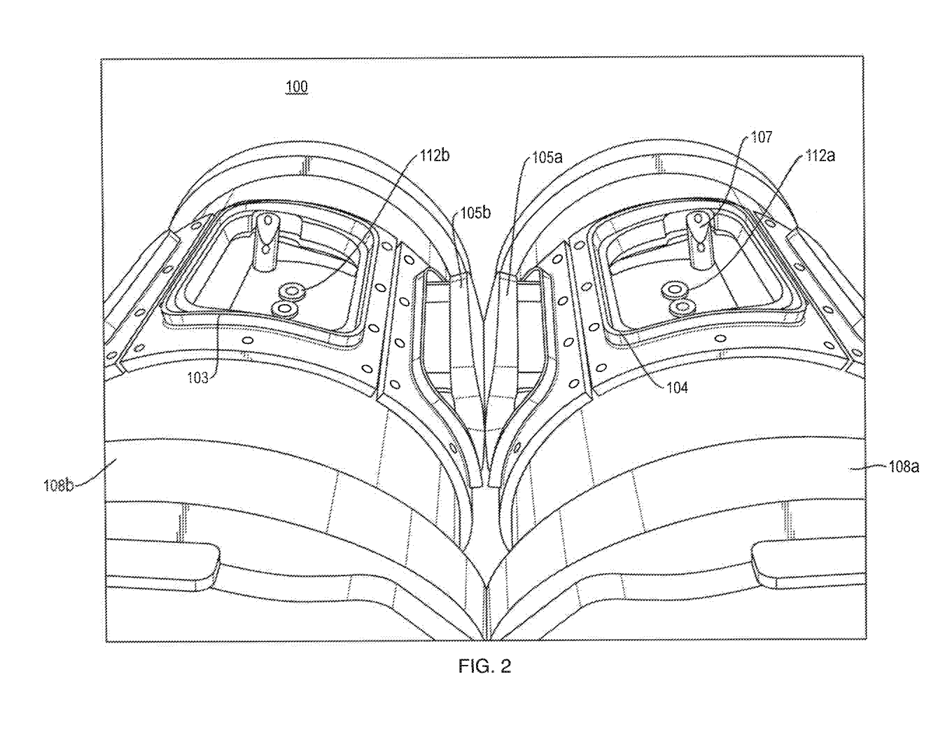

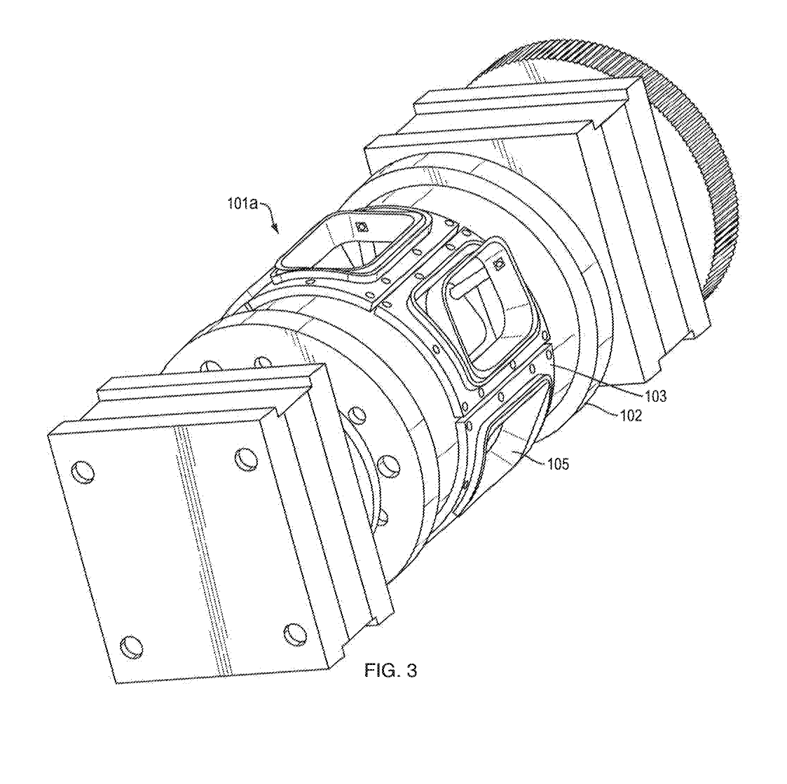

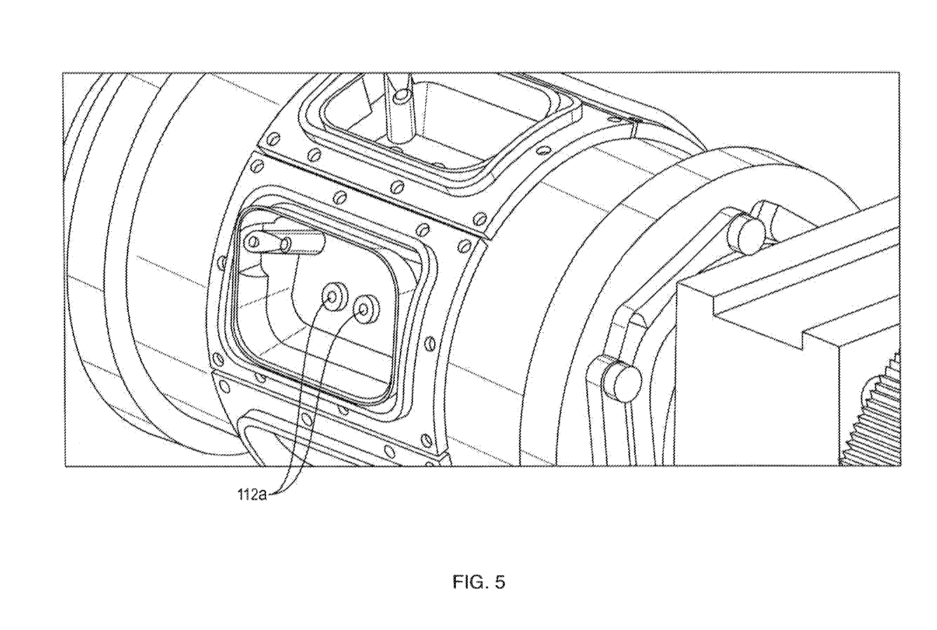

As such, FIGS. 1-7 are exemplary views of illustrative three dimensional part rotary die mechanism of the illustrative embodiment of the present invention. As can be seen from FIGS. 1-3 the rotary die assembly 100 is made up of a plurality of components. FIG. 1 illustrates an example perspective view of the overall configuration of the rotary die cutting mechanism; FIG. 2 illustrates an example perspective view of the rotary die cutting mechanism assembly; and FIG. 3 illustrates an example perspective view of a first drum of the rotary die cutting mechanism.

In particular, drums 101a,b are disposed in a mounting structure adjacently parallel each rotating on respective axes. The pair of drums includes a first drum 101a and a second drum 101b. The first and second drums 101a,b are configured to rotate in opposing directions continuously in order to continuously receive and trim parts. The drums 101a,b are rotated by gears 108a,b and bearing assemblies 102a,b respectively. The drums 101a,b may be in any shape capable of performing rotary die cutting of three dimensional parts. For example, the drums may be cylindrical or hexagonal in shape. However, preferably the drums are cylindrical drums having a smooth outer circumferential surface.

Formed in an outer surface of each of the drums 101a,b is at least one recess and preferably a plurality of recesses 106a,b allowing increased production efficiency. Protruding from a perimeter on the outer surface of the first drum 101a of each of the recesses 106a may be an anvil 103 or an anvil like structure thus forming a cutting surface. Conversely protruding from a perimeter on the outer surface of the second drum 101b of each of the recesses 106b may be a cutting mechanism 104 (e.g., a knife). Thus, as a result, the anvils 103 protrude outward from the circumferential surface at an edge of the recesses 106a, and cutting mechanisms protrude outward from the circumferential surface at an edge of the recesses 106b.

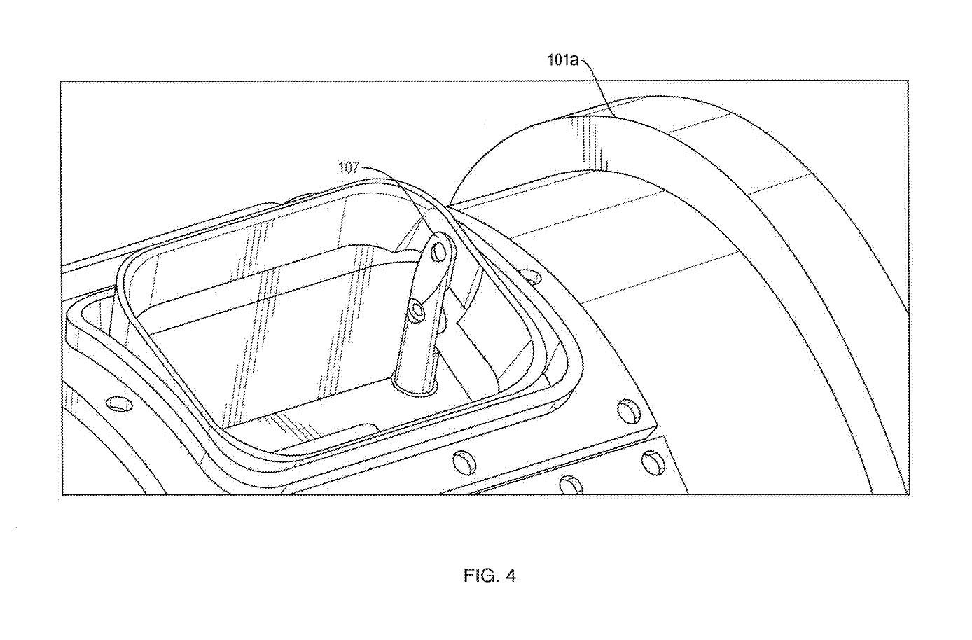

Within each of the recessions 106a,b of both the first drum 101a and the second drum 101b, a capturing mechanism 105a,b is installed. These capturing mechanisms 105a, are actuated by, e.g., a piston rod 107 (discussed later in relation to FIG. 4) so that when an three dimensional part 1115 is, for example, placed in a capturing mechanism 105a of the first drums 101a and then rotated with the first drum 101a toward the second drum 101b, the capturing mechanisms 105a,b are actuated in an outward direction toward each other so the three dimensional part 115 is retained or fixed between an opposing capturing mechanisms 105b and 105a. As, in order to receive a three dimensional part, each capturing mechanisms 105a,b (i.e., a pair of capturing mechanisms) are formed in a hoop shape with an aperture formed in the middle thereof, and more specifically, in the illustrative embodiment of the present invention, a rectangular hoop shape with rounded corners may be used, although the illustrative embodiment of the present invention is not limited thereto.

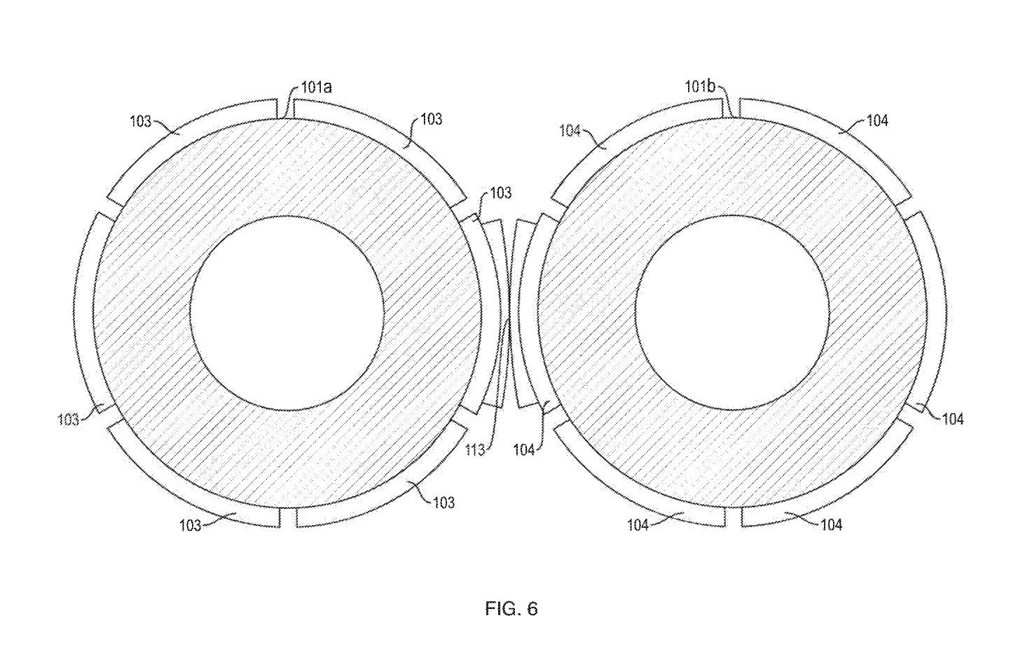

The drums 101a,b are rotated in a synchronized manner (and in opposite rotational directions) so that at a trimming position 113 (See FIG. 6), an anvil 103 protruding from an recess 106a of the first drum 101a comes in substantial contact with an edge of the cutting mechanism 104 (e.g., a knife) of an recess 106b in the second drum 101b to trim the three dimensional part 115 that is retained by the capturing mechanisms 105 as the drums rotate.

Also during the rotation, as mentioned above, in order to hold the three dimensional part 115 in a proper orientation to allow the three dimensional part(s) 115 to be cut (i.e., perpendicular to the cutting surface), the pair of capturing mechanisms 105a,b is formed within each of the pair of recesses 106a,b and are configured to move in relation to the rotation of the drums 101a,b. Thus, when the capturing mechanisms 105a,b are rotated to the trimming position 113, the capturing mechanisms 105a,b move outward toward each other and grip or hold the three dimensional part 115 therebetween in an orientation that is perpendicular to the cutting surface of the anvil 103 and cutting mechanism 104 respectively in order to properly cut or trim the three dimensional part 115.

In order to insure a proper cut around the entire three dimensional part, the cutting mechanism 104 may be formed and protrude along an entire perimeter the recess 106b. Additionally, as shown by the profile in FIG. 6 cutting mechanism 104 may be and is preferably formed with a curved contour along at least two sides of the perimeter of the recesses 106a,b. As can be seen from the side profile, the cutting mechanism 104 and the anvil 103 are disposed to abut the outer circumferential surface of the each of the drums 101a,b respectively.

As can be seen in FIGS. 2 and 6 which show the rotary die cutting mechanism 100 in a trimming position 113, when the rotary die cutting mechanism is in the trimming position 113, one pair of capturing mechanisms 105a,b are actuated outward, while the other capturing mechanisms are contracted inward. As such, the actuation of the capturing mechanisms 105a,b may be controlled by a piston rod 107 (FIG. 4) that may be actuated by, for example, hydraulic, gravitational or any other actuation means which will allow for a controlled actuation of the capturing mechanisms 105. Accordingly, each of the pair of capturing mechanisms 105a,b are actuated toward each other when a rotation of the drums is at the trimming position 113 via the piston rod 107. The piston rod 107 may be connected rotatably at one end to one of a capturing mechanism 105 and connected at an opposite end to an inner surface of one of the drums respectively. In operation, the piston rod 107 may move in and out either rotationally or linearly in order to actuate the capturing mechanisms 105a,b.

Additionally, in some exemplary embodiments of the present invention, as shown in FIGS. 1-2 and 5, suction may be applied to the three dimensional part(s) 115 by at least one suction mechanism 112a,b in each recess 106a,b to further retain the three dimensional part(s) 115 in the recess 106a,b of the first drum 101a, respectively. Preferably, one or more suction mechanisms 112a,b may be installed on the inner surface of recesses of the drums. These suction mechanisms 112a,b may be embodied, for example, as vacuum cups via which a suction force is applied depending on the rotational position of the suction mechanisms 112a,b. As such, the suction force may be applied upon the three dimensional part 115 being positioned in each capturing mechanism 105a and then turned off when the three dimensional part 115 is to be ejected from the rotary die cutting mechanism 100.

Furthermore, in some exemplary embodiments of the present invention, the structure of the cutting mechanisms 104 and the anvils 103 may be integrated with the outer circumferential surface of the each of the drums or may be separately mounted components without departing from the overall concept of the illustrative embodiment of the present invention. Additionally, the shape of the recesses and the corresponding cutting mechanisms and anvils is not necessary limited to a particular shape. That is, although the recesses, anvils and cutting mechanisms are shown as substantially rectangular in nature, the illustrative embodiment of the present invention is not necessarily limited thereto and instead, each of these components may be formed in any shape desirable and required in order to receive an appropriate three dimensional part.

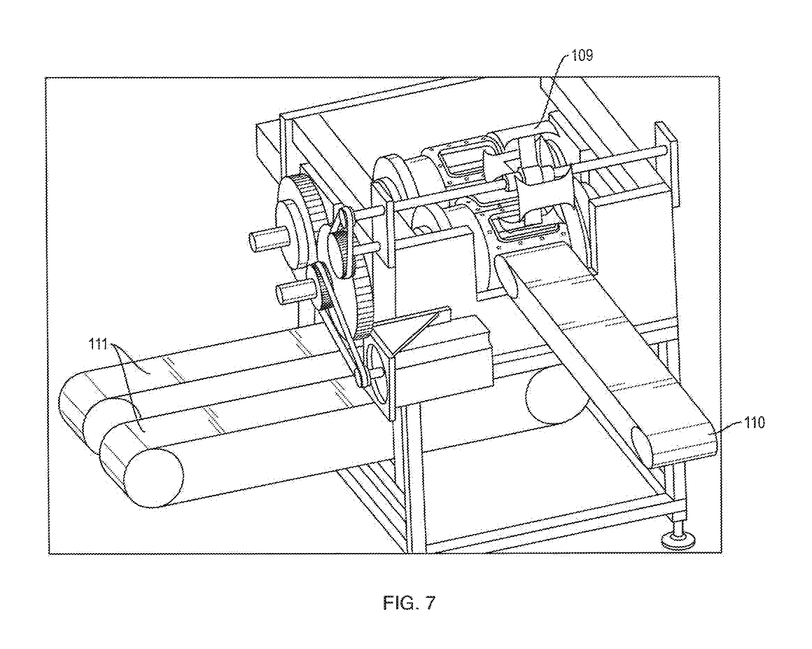

For example, referring to FIG. 1 and to FIG. 7, in the illustrative embodiments of the present invention, three dimensional parts 115 that are being received by the rotary die cutting mechanism 100 via a first conveyor 110 and a feeder 109 and are in the exemplary embodiment substantially rectangular shaped containers for packaging food. The three dimensional parts 115 may advantageously include two separate components abutting each other in a manner allowing a corresponding surface of both components to be trimmed at the same time (e.g., in a claim shell like manner as can be seen in FIG. 1). Therefore, in order to properly receive such a three dimensional part, the recesses 106a,b, capturing mechanisms 105a,b, anvils 103 and cutting mechanisms 104 are all formed in substantially a rectangular shape in the illustrative embodiment of the present invention.

However, these same trays may be produced in any shape, such as for example, a substantially circular shape. In such a scenario, the recesses 106a,b, capturing mechanisms 105a,b, anvils 103 and cutting mechanisms 104 would also be formed in a substantially circular shape. Accordingly, the shape of these components of the illustrative embodiment of the present invention is not limited thereto. As such, the recesses may be configured to receive any number of different types of individual three dimensional parts.

Referring to FIG. 7 in particular, the feeder 109 may be embodied as a rotary hook like structure that is configured to position the three dimensional part within the recesses 106a,b in the appropriate position within a capturing mechanism 105a, however, the illustrative embodiment of the present invention is not limited to such a feeder. Regardless, the three dimensional parts 115 are moved from the first conveyor 110 to the recesses 106a of the first drum 101a. The three dimensional parts are then trimmed by the rotary die cutting mechanism and are ejected onto a second conveyor 111 to be delivered to the next step in the production process.

The illustrative rotary die cutting mechanism provides a method for effectively and efficiently trimming/cutting the three dimensional part is provided. In particular, a three dimensional part may fed into a rotary die mechanism which is continuously rotating. The three dimensional part is rotated toward a trimming position upon reaching the trimming position, the three dimensional part is retained in an in orientation that is perpendicular to a cutting surface on the rotary die cutting mechanism. The three dimensional part is then trimmed at the trimming position, and the trimmed three dimensional part is ejected from the rotary die cutting mechanism after the three dimensional part is rotated a distance from the trimming position. In particular, a first and second capturing mechanism may be actuated to capture and retain the three dimensional part therebetween in order to orientate the three dimensional part in the perpendicular orientation to the cut-ting surface.

More specifically, the illustrative embodiment of the present invention is operated by feeding a three dimensional part or parts into a first capturing mechanism 105a attached to a first drum 101a within a first recess 106a formed within a surface of the first drum 101a. The first drum 101a and a second drum 101b are rotated in opposing rotational directions continuously in order to move the three dimensional part 115 into the trimming position 113. Upon reaching the trimming position 113, the three dimensional part 115 is captured between the first capturing mechanism 105a and a second capturing mechanism 105b disposed in the second recess 106a of the second drum 101b when the first drum 101a and the second drum 101b are rotated to a trimming position 113. The three dimensional part is trimmed via the cutting mechanism 104 disposed on the first drum 101a coming in contact with the three dimensional part 115 at the trimming position 113 against the anvil 103. Once the three dimensional part is trimmed, the trimmed three dimensional part is ejected from the first capturing mechanism 105a,b after the drums have rotated a certain distance from the trimming position (e.g., about 90 degrees).

As stated above the first and second drums are rotated in a synchronized manner so that at the trimming position the anvil 103 of the second drum 101b come in substantial contact momentarily with an edge of the cutting mechanism 104 of the first drum 101a to trim the three dimensional part 115 retained by the first and second capturing mechanisms 105a,b. In order to do so, the first and second capturing mechanisms 105a,b are actuated toward each other when a rotation of the drums 101a,b is at the trimming position via the rod 107 (e.g., a piston rod) connected rotatably at one end the first and second capturing mechanisms 105a,b respectively and connected at an opposite end to an inner surface of the first and second drums 101a,b respectively.

Additionally, if a suction mechanism is utilized, upon positioning the three dimensional part 115 in the first recess 106a, applying suction to a surface of the three dimensional part 115 to hold the three dimensional part in the first recess 106a. The suction is applied by at least one suction mechanism formed on the inner surface of the drum in each of the at least one pair of recesses. The at least one suction mechanism accordingly secures the three dimensional part 115 in each of the recesses. The application of suction is eliminated once the three dimensional part 115 has been trimmed to eject the three dimensional part 115 so that the three dimensional part may be ejected onto, e.g., a conveyor belt 111.

It should be noted that while certain steps within operational procedures be optional as described above, these steps are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while the below operational procedures are described separately, certain steps may occur almost of substantially simultaneously, and the procedures are not meant to be mutually exclusive or in any particular order.

The novel techniques described herein, therefore, provide efficiency and effective means for trimming three dimensional three dimensional parts via a rotary die cutting mechanism by utilizing the above mentioned capturing mechanisms. As such, the three dimensional parts may be trimmed effectively and efficiently because the capturing mechanisms maintain the three dimensional parts in the proper orientation for trimming of the part. Additionally, the number of three dimensional parts that can be trimmed per minute can be increased due to the degree of accuracy and efficiency of the described rotary die cutting mechanism and also due to the ability to abut two or more parts against each other and trim two or more parts at once (e.g., in an claim shell like manner).

While there have been shown and described illustrative embodiments that provide a rotary die cutting mechanism for trimming three dimensional three dimensional parts, it is to be understood that various other adaptations and modifications may be made within the spirit and scope of the embodiments herein. For example, the embodiments have been shown and described herein with relation to the feeding means. However, the embodiments in their broader sense are not as limited, and may, in fact, be used with other types of types of feeding means without departing from the overall spirit of the apparatus and method of operation thereof. Also, while the description above relates to

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. An apparatus comprising:
a first and second drum adjacent to each other to rotate about a respective axis of the first and second drum respectively;
a first recess formed on an outer surface of the first drum;
a second recess formed on an outer surface of the second drum;
an anvil protruding outward from the first recess of the first recess;
a cutting mechanism protruding outward from the second recess;
a first capturing mechanism disposed within the first recess and movable based on the rotation of the first drum; and
a second capturing mechanism disposed with the second recess and movable based on the rotation of the second drum.

2. The apparatus of claim 1, wherein the first drum includes more than one first recess, anvil and first capturing mechanism combination and the second drum includes more than one second recess, anvil and first capturing mechanism combination that correspond to the first drum.

3. The apparatus of claim 1, wherein the first drum and the second drum are rotated in a synchronized manner so that at a trimming position, the anvil comes in substantial contact with an edge of the cutting mechanism to trim a three dimensional part retained by the capturing mechanisms.

4. The apparatus of claim 3, wherein the three dimensional part includes two separate components abutting each other in a manner allowing a corresponding surface of both components to be trimmed at the same time.

5. The apparatus of claim 1, wherein the first and second capturing mechanisms are hoop shape with an aperture formed in a middle thereof to receive a three dimensional part.

6. The apparatus of claim 1, wherein the first and second capturing mechanisms are actuated toward each other when the rotation of the drums is at a trimming position via a piston rod.

7. The apparatus of claim 1, wherein the apparatus further comprises:
at least one suction mechanism formed on an inner surface of each of the first and second recesses, the at least one suction mechanism further securing a three dimensional part into each of the recesses.

8. The apparatus of claim 7, wherein more than one suction mechanism are installed on the inner surface of the drum.

9. The apparatus of claim 7, wherein the suction mechanism is a vacuum cup.

10. The apparatus of claim 1, wherein each of the first and second drums include a bearing ring that is disposed on at least one end of the drum and a gear formed on an opposing end.

11. The apparatus of claim 1, wherein the cutting mechanism is a knife.

12. The apparatus of claim 1, wherein the cutting mechanism is formed and protrudes along an entire perimeter of the second recess, and the cutting mechanism is formed with a curved contour along at least two sides of the perimeter of the second recess.

13. The apparatus of claim 1, wherein the capturing mechanism is a substantially rectangular hoop with rounded corners.

14. The apparatus of claim 1, wherein the cutting mechanism and the anvil are disposed to abut the outer circumferential surface of the each of the drums respectively.

15. The apparatus of claim 1, wherein the cutting mechanism and the anvil are integrated with the outer surface of the first and second drum respectively.

16. The apparatus of claim 1, wherein the first recess and the second recess each receive a portion of the three dimensional part, and the at least one pair of capturing mechanisms is configured to retain the three dimensional three dimensional part at a position that is perpendicular to a cutting surface of the cutting mechanism when the first and second drums are at a trimming position.

17. The apparatus of claim 1, wherein the first and second drums rotate in opposing directions continuously.

18. The apparatus of claim 1, wherein the first and second drums are cylindrical.

19. A method comprising:
feeding a three dimensional part into a rotary die cutting mechanism;
rotating the three dimensional part toward a trimming position;
retaining the three dimensional part in an in orientation that enables trimming thereof in the trimming position;
trimming the three dimensional part at the trimming position; and
ejecting the trimmed three dimensional part from the rotary die cutting mechanism after the three dimensional part is rotated a distance from the trimming position.

20. The method of claim 19, wherein three dimensional parts are continuously fed into the rotary die cutting mechanism.

21. The method of claim 19, further comprising actuating a first and second capturing mechanism to capture and retain the three dimensional part therebetween in order to orientate the three dimensional part in the perpendicular orientation to the cutting surface.

22. The method of claim 19, further comprising
applying suction to a surface of the three dimensional part to hold the three dimensional in the rotary die cutting mechanism; and
eliminating the application of suction once the three dimensional part has been trimmed to eject the three dimensional part.
